(19) United States
(12) Patent Application Publication
(10) Pub. No.: US 2013/0286444 A1
(43) Pub. Date: Oct. 31, 2013

(54) Laptop Document Scanning System and Method

(71) Applicant: Petra Bergstein, Lubbock, TX (US)

(72) Inventor: Petra Bergstein, Lubbock, TX (US)

(21) Appl. No.: 13/457,579

(22) Filed: Apr. 27, 2012

(51) Int. Cl. H04N 1/04

(52) U.S. Cl. 358/401

(57) ABSTRACT

A laptop document scanner is disclosed comprising a laptop having a base portion, a display portion having a screen, and a hinging assembly. Said screen is capable of emitting light and sensing light. Said hinging assembly is capable of rotatably connecting said base portion to said display portion. Said base portion and said display portion are capable of rotatably transitioning between a closed-configuration and an open-configuration. Said screen is capable of displaying one or more images on said screen. Said screen is capable of scanning one or more images of one or more target objects. Said base portion and said display portion are capable of holding said one or more target objects while said screen is scanning said one or more images of said one or more target objects.

### BACKGROUND

This disclosure relates generally to a laptop document scanning system and method.

None of the prior inventions and patents, taken either singularly or in combination, is seen to describe the instant disclosure as claimed. Accordingly, an improved laptop document scanning system and method would be advantageous.

### SUMMARY

Two laptop document scanners and a laptop document scanning method are disclosed.

A laptop document scanner is disclosed comprising a laptop having a base portion, a display portion having a screen, and a hinging assembly. Said screen is capable of emitting light and sensing light. Said hinging assembly is capable of rotatably connecting said base portion to said display portion. Said base portion and said display portion are capable of rotatably transitioning between a closed-configuration and an open-configuration. Said screen is capable of displaying one or more images on said screen. Said screen is capable of scanning one or more images of one or more target objects. Said base portion and said display portion are capable of holding said one or more target objects while said screen is scanning said one or more images of said one or more target objects.

A laptop document scanning method is disclosed comprising scanning one or more target objects with a laptop by: placing a screen of said laptop near said one or more target objects, holding said one or more target objects between a base portion and a display portion of said laptop, engaging said screen to read a portion of said one or more target objects, acquiring an image data from said screen, processing said image data into an image file, and storing said image file with said laptop. Said laptop comprises said base portion, said display portion having said screen, and a hinging assembly. Said screen is capable of emitting light and sensing light. Said screen is capable of displaying one or more images on said screen. Said screen is capable of scanning one or more images of one or more target objects. Said hinging assembly is capable of rotatably connecting said base portion to said display portion. Said base portion and said display portion is capable of rotatably transitioning between a closed-configuration and an open-configuration.

Finally, a laptop document scanner is disclosed comprising a laptop having a base portion, a display portion having a screen, and a hinging assembly. Said screen is capable of emitting light and sensing light. Said hinging assembly is capable of rotatably connecting said base portion to said display portion. Said base portion and said display portion are capable of rotatably transitioning between a closed-configuration and an open-configuration. Said screen is capable of displaying one or more images on said screen. Said screen is capable of scanning one or more images of one or more target objects. Said base portion and said display portion are capable of holding said one or more target objects while said screen is scanning said one or more images of said one or more target objects. Scanning said one or more target objects comprises: placing said screen near said one or more target objects, engaging said screen to read a portion of said one or more target objects, acquiring an image data from said screen, processing said image data into an image file, and storing said image file with said laptop.

### BRIEF DESCRIPTION OF THE DRAWINGS

FIG. 1 illustrates a perspective overview of a laptop and a target object.

FIGS. 2A and 2B illustrate a perspective overview and side view of laptop.

FIG. 3 illustrates a perspective overview of target object on said base portion of said laptop.

FIG. 4 illustrates a perspective overview of laptop in said closed-configuration.

FIGS. 5A, 5B and 5C illustrate a flow chart of a plurality of computer hardware components of said laptop, a flow diagram of laptop while scanning a portion of said target object, and a step chart for scanning a portion of said target object.

FIGS. 6A, 6B, 6C and 6D illustrate an elevated top view of said display portion having an edges marker, and a plurality of embodiments of said image data.

FIG. 6A illustrates an elevated top view of said base portion with said edges marker overlaid.

FIG. 6B illustrates a base image.

FIG. 6C illustrates an embodiment of a non-base image.

FIG. 6D illustrates an embodiment of said image data comprising a target object portion and a base image portion.

FIG. 6E illustrates a perspective overview of laptop displaying a scanned image of said target object.

FIGS. 7A and 7B illustrate a perspective overview of laptop in a collapsed-configuration and an expanded-configuration, respectively.

FIGS. 8A and 8B illustrate a perspective detailed overview of said hinging assembly of laptop, in said collapsed-configuration and said expanded-configuration.

FIGS. 8C and 8D illustrate an elevated side view of laptop in said collapsed-configuration and an elevated side view of laptop in said expanded-configuration.

FIGS. 9A and 9B illustrate an elevated cross-section side view of said hinging assembly of laptop in said collapsed-configuration and said expanded-configuration.

FIGS. 10A and 10B illustrate a perspective overview and side view of said laptop with a book.

### DETAILED DESCRIPTION

Described herein is a laptop document scanning system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

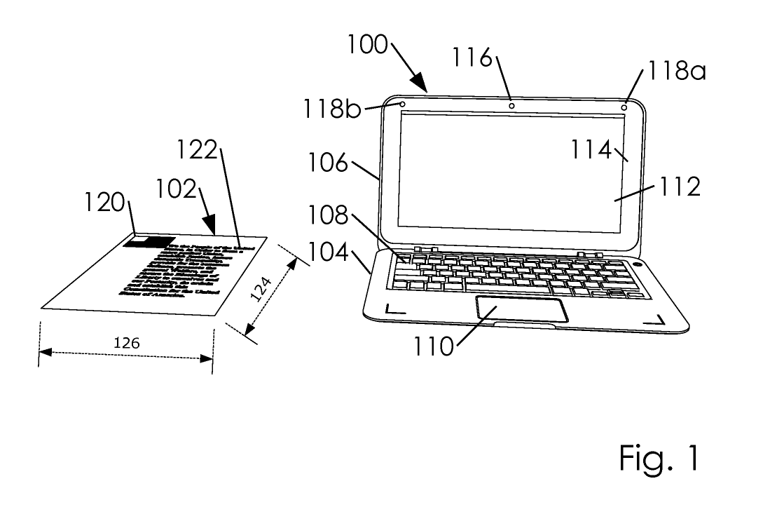

FIG. 1 illustrates a perspective overview of a laptop 100 and a target object 102. In one embodiment, said laptop document scanning system and method can comprise one or more components within said laptop 100 capable of capturing an image from said target object 102. In one embodiment, said laptop document scanning system and method can comprise a laptop document scanner. Laptop 100 can comprise a base portion 104 and a display portion 106. Laptop 100 can comprise a keyboard 108, a track-pad 110, a screen 112, a bezel 114, and a camera 116. In one embodiment, laptop 100 can comprise one or more sensors, such as a first sensor 118a and a second sensor 118b. In one embodiment, target object 102 can comprise a piece of paper, a page in a book/magazine, etc. In one embodiment, target object 102 can comprise one or more images 120 and/or a text 122. In one embodiment, target object 102 can comprise a height 124 and a width 126.

Laptop 100 can comprise one of many brands and varieties of computers manufactured by a wide range of laptop manufacturers. Any similarities of laptop 100, as illustrated, to a particular model of laptop is for illustrative purposes and should not be construed as limiting the subject matter of this disclosure or claims thereupon.

In one embodiment, screen 112 can comprise a plurality of pixels capable of displaying one or more images on said screen 112. In one embodiment, said plurality of pixels can comprise LED, OLED, plasma or similar pixel types. In one embodiment, said OLED can comprise an Organic Light Emitting Diode. In one embodiment, screen 112 can be capable of emitting light and sensing light. Examples of screen 112 emitting light are well known in the art. Examples of screen 112 being capable of sensing light are discussed as follows. In one embodiment, said screen 112 can be capable of scanning one or more images of one or more target objects 102.

In U.S. Pat. No. 7,745,817, Mr. Jonathan Halls discloses one such example of an embodiment of screen 112 capable of sensing light (referred to at one point as “a plurality of light sensing devices”). Likewise, Mr. Wei discloses a similar embodiment of said screen 112 in in U.S. Pat. No. 5,929,845. Mr. Wei discloses an image scanner and display comprising an array of organic electroluminescent devices, each device operating as a light emitter when forward biased (one embodiment of said light emitting capability of said screen 112) and as a light detector when reversed biased (one embodiment of said light sensing capability of said screen 112). Likewise, Mr. Booth discloses a similar embodiment of said screen 112 in U.S. Pat. No. 8,026,879. Each of U.S. Pat. Nos. 7,745,817, 5,929,845, and 8,026,879 are hereby incorporated by reference as a plurality of embodiments of said screen 112.

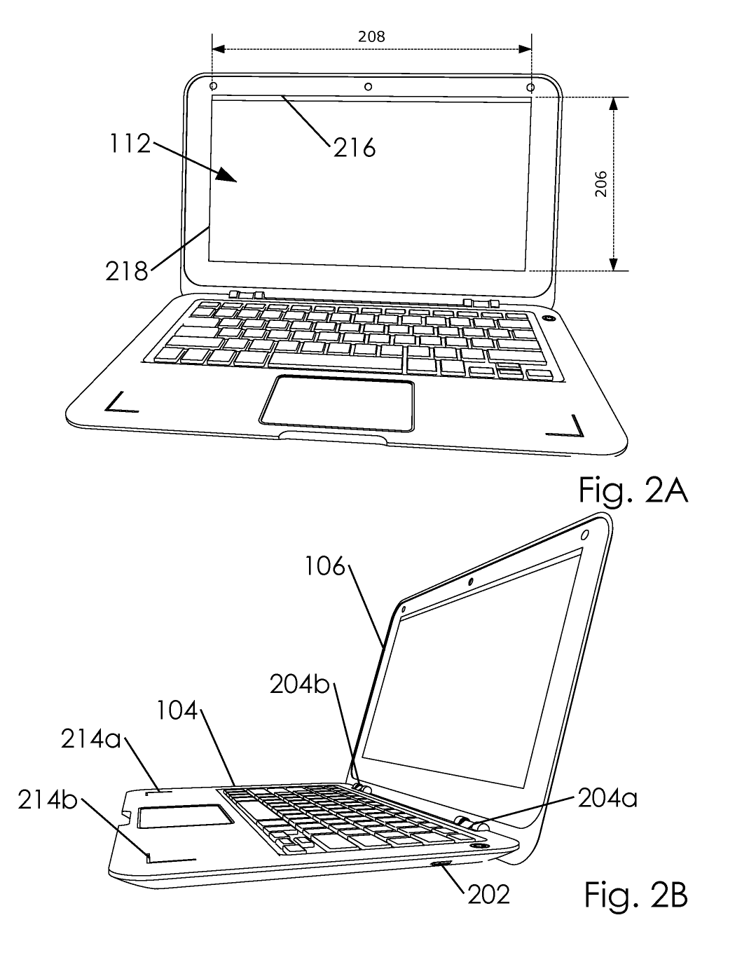

FIGS. 2A and 2B illustrate a perspective overview and side view of laptop 100. In one embodiment, said laptop 100 can comprise a button 202. In one embodiment, engaging said screen 112 to read a portion of said target object 102 can comprise pressing said button 202. In one embodiment, laptop 100 can comprise a hinging assembly. In one embodiment, said hinging assembly of laptop 100 can comprise a first hinge 204a and a second hinge 204b. In one embodiment, screen 112 can comprise a height 206 and a width 208.

In one embodiment, said display portion 106 can comprise said screen 112 and said base portion 104 can comprise said keyboard 108. In one embodiment, said display portion 106 is capable of rotatably connecting to said base portion 104 with said hinging assembly of laptop 100.

In one embodiment, said base portion 104 can comprise one or more markers. In one embodiment, said one or more markers can comprise a first marker 214a and a second marker 214b. In one embodiment, said screen 112 can comprise a top edge 216 and a circumference 218.

In one embodiment, said laptop 100 can transition between an open-configuration and a closed-configuration. In one embodiment, said closed-configuration can comprise said display portion 106 and said base portion 104 substantially touching one another and substantially parallel to one another. In one embodiment, said open-configuration can comprise said display portion 106 and said base portion 104 not in said closed-configuration; wherein, said screen 112 and said keyboard 108 are accessible.

In one embodiment, said one or more markers can correspond to a portion of said circumference 218 as pressed against said base portion 104 with said laptop 100 in said closed-configuration. For example, in one embodiment, said one or more markers can comprise an “L” shape. In one embodiment, a first portion of said “L” shape of said one or more markers can be substantially parallel with said top edge 216. In one embodiment, a second portion of said “L” shape of said one or more markers can be substantially perpendicular to said first portion of said one or more markers. In one embodiment, with said laptop 100 in said closed-configuration, said top edge 216 can align with said first portions of said “L” shape of said one or more markers. Thus, in one embodiment, said first portions of said “L” shape of said one or more markers can mark a location of said top edge 216 when said laptop 100 is in said closed-configuration. In one embodiment, said second portions of said “L” shape of said one or more markers can be separated from one another by said width 208 of said screen 112. Thus, in one embodiment, said second portions of said “L” shape of said one or more markers can mark out one or more side edges of said screen 112 when said laptop 100 is in said closed-configuration.

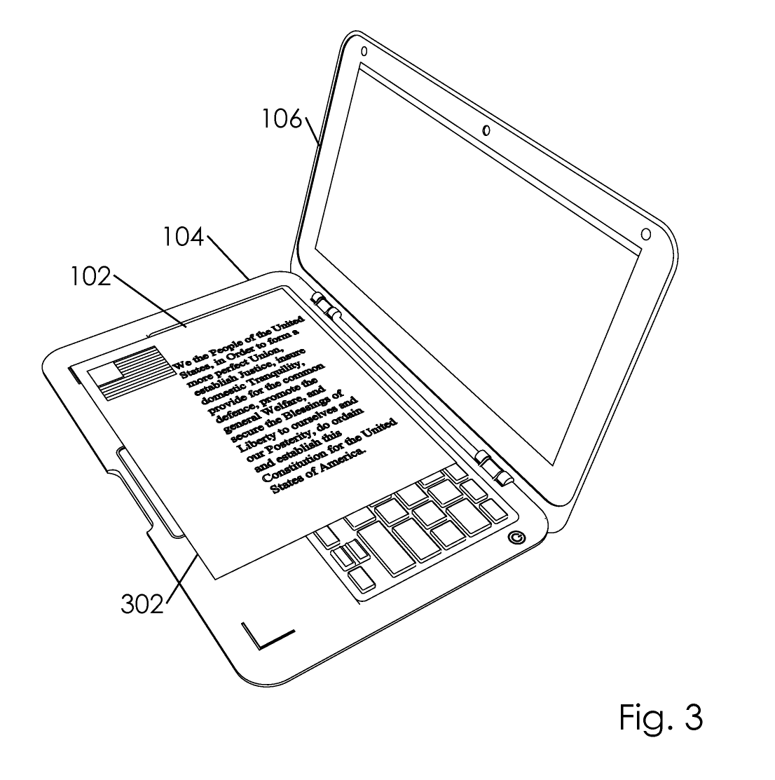

FIG. 3 illustrates a perspective overview of target object 102 on said base portion 104 of said laptop 100. In one embodiment, width 126 of target object 102 can be less than or equal to height 206 of screen 112. In one embodiment, height 124 of target object 102 can be less than or equal to said width 208 of said screen 112. In one embodiment, said target object 102 can comprise one or more edges 302.

In one embodiment, aligning said target object 102 for scanning can comprise: placing said target object 102 onto said base portion 104, orienting said target object 102 with said one or more images 120 and/or text 122 facing upward toward said display portion 106; and aligning said one or more edges 302 with one or more of said one or more markers on said base portion 104.

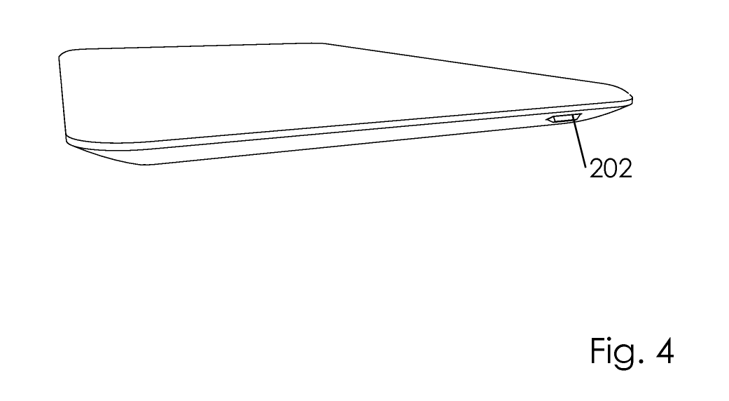

FIG. 4 illustrates a perspective overview of laptop 100 in said closed-configuration.

In one embodiment, laptop 100 can be capable of holding said target object 102 between said base portion 104 and said display portion 106 by: placing a portion of said target object 102 between said base portion 104 and said display portion 106 and transitioning said laptop 100 into said closed-configuration. In another embodiment, holding said target object 102 between said base portion 104 and said display portion 106 can comprise: opening said laptop 100 into said open-configuration; placing said target object 102 on said base portion 104; and closing said display portion 106 over said target object 102.

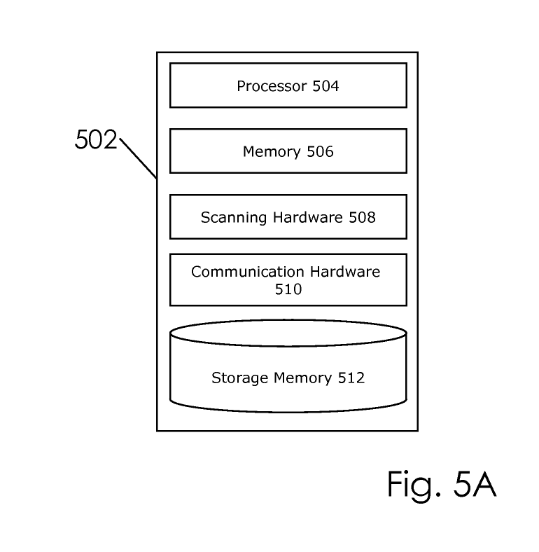

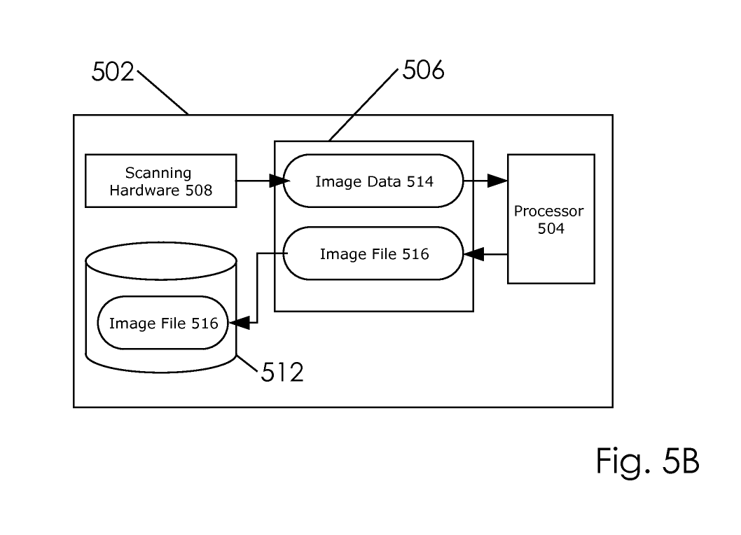

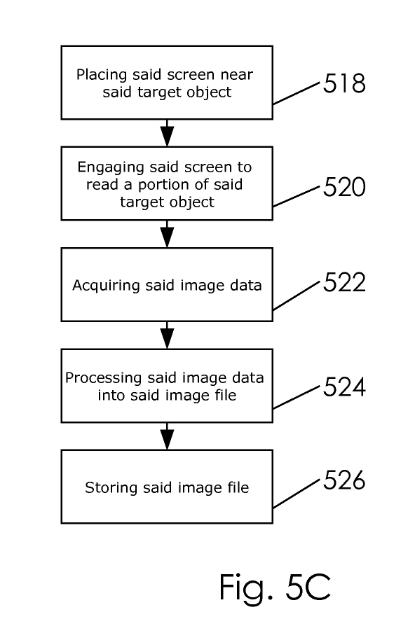

FIGS. 5A, 5B and 5C illustrate a flow chart of a plurality of computer hardware components 502 of said laptop 100, a flow diagram of laptop 100 while scanning a portion of said target object 102, and a step chart for scanning a portion of said target object 102.

Said plurality of computer hardware components 502 of said laptop 100 can comprise a processor 504, a memory 506, a scanning hardware 508, a communication hardware 510, a storage memory 512 and other components as are common in the field. In one embodiment, plurality of computer hardware components 502 can comprise a software program held in said memory 506 and executed in said processor 504. In one embodiment, said scanning hardware 508 can comprise said screen 112; wherein, said screen 112 can be capable of emitting light and sensing light, as discussed supra. In one embodiment, said communication hardware 510 can comprise a modem, a wireless modem (such as wi-fi, 802.11a, 802.11b, 802.11c, 802.11g, 802.11n, 3G cellular data, 4G cellular data), or similar. In one embodiment, said storage memory 512 can hold a portion of said memory 506, as is common in the art.

In one embodiment, scanning of a portion of said target object 102 with said screen 112 can comprise placing said screen 112 near said target object 102, engaging said screen 112 to read a portion of said target object 102, reading a portion of said target object 102, acquiring an image data 514 of said portion of said target object 102 from said screen 112, processing said image data 514 into an image file 516, and storing said image file 516. In one embodiment, scanning a portion of target object 102 can further comprise illuminating a portion of said target object 102 with said screen 112 while reading said portion of said target object 102. In one embodiment, reading a portion of said target object 102 can comprise sensing light reflecting from said target object 102 with said plurality of pixels. In one embodiment, acquiring said image data 514 can comprise capturing an array of readings from said plurality of pixels, as is well known in the art. In one embodiment, storing said image file 516 can comprise collecting said image data 514 into a computer readable file holding a portion of a copy of said image data 514.

In one embodiment, acquiring said image data 514 of said portion of said target object 102 can comprise: collecting said image data 514 from said scanning hardware 508, and delivering said image data 514 to said memory 506. In one embodiment, processing said image data 514 into said image file 516 can comprise delivering said image data 514 to said processor 504 and converting said image data 514 into said image file 516. In one embodiment, converting said image data 514 into said image file 516 can comprise running said software program in processor 504. In one embodiment, processor 504 can output said image file 516 into said memory 506 or said storage memory 512. In one embodiment, said memory 506 can deliver said image file 516 to said storage memory 512.

In one embodiment, said laptop document scanning system and method can comprise scanning of a portion of said target object 102 with said screen 112 by: an positioning step 518, an engaging step 520, an acquiring step 522, a processing step 524, and a storing step 526. In one embodiment, said engaging step 520 can comprise placing said screen 112 near said target object 102. In one embodiment, said acquiring step 522 can comprise engaging said screen 112 to read a portion of said target object 102. In one embodiment, said acquiring step 522 can comprise acquiring said image data 514 from said scanning hardware 508. In one embodiment, said processing step 524 can comprise processing said image data 514 into said image file 516. In one embodiment, said storing step 526 can comprise storing said image file 516 with said memory 506 and/or said storage memory 512.

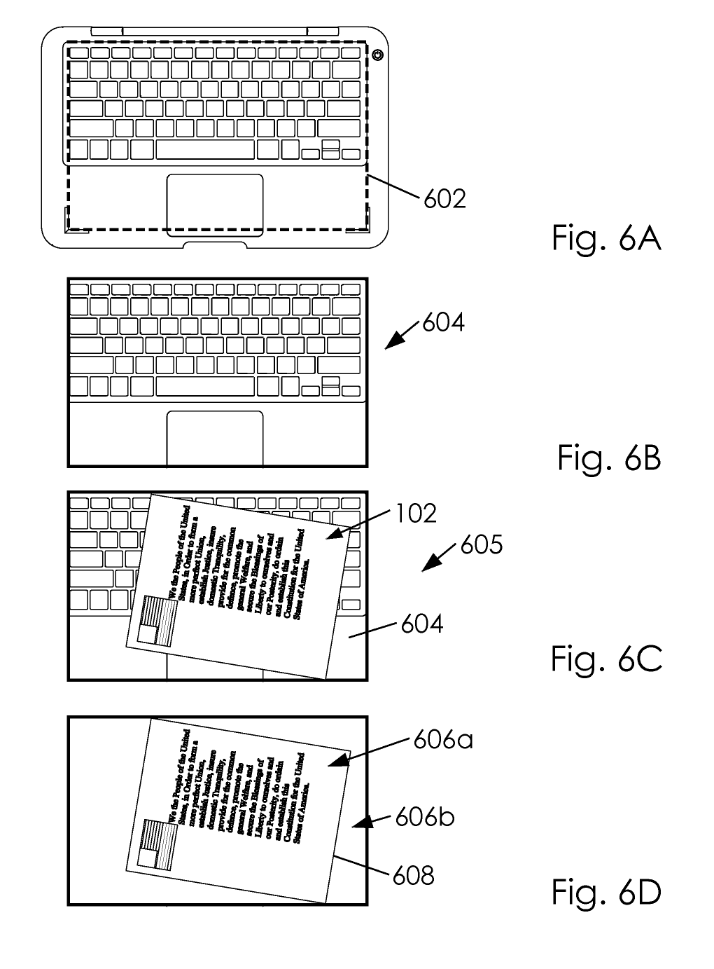

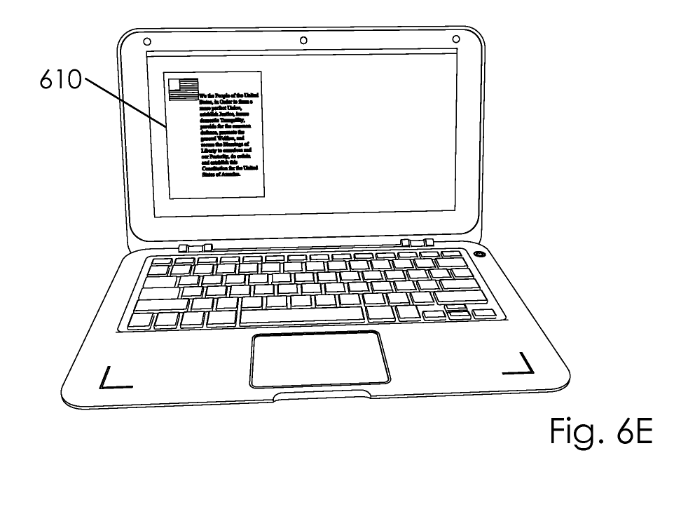

FIGS. 6A, 6B, 6C and 6D illustrate an elevated top view of said display portion 106 having an edges marker 602, and a plurality of embodiments of said image data 514.

FIG. 6A illustrates an elevated top view of said base portion 104 with said edges marker 602 overlaid. In one embodiment, said edges marker 602 can comprise a location at which said one or more edges of said screen 112 will touch said base portion 104 with said laptop 100 is in said closed-configuration.

FIG. 6B illustrates a base image 604. As discussed, supra, scanning with said laptop 100 can render said image data 514. In one embodiment, said image data 514 can comprise said base image 604. In one embodiment, said base image 604 can comprise a scan of a portion of said base portion 104 inside of said edges marker 602. In one embodiment, scanning said base portion 104 without an object (such as said target object 102) between said display portion 106 and said base portion 104.

FIG. 6C illustrates an embodiment of a non-base image 605. In one embodiment, said image data 514 can comprise said non-base image 605. In one embodiment, said non-base image 605 can comprise a scan of said base image 604 having one or more objects (such as said target object 102) between said base portion 104 and said display portion 106. In one embodiment, processing said image data 514 can comprise: detecting a portion of said target object 102 in said image data 514 and isolating said target object 102. In one embodiment, detecting said target object 102 between said base portion 104 and said display portion 106 can comprise: establishing said base image 604 by scanning said base portion 104 without an object between said base portion 104 and said display portion 106; and, comparing said newly scanned image to said base image 604; wherein, said target object 102 are in said image data 514 if said newly scanned image is substantially dissimilar to said base image 604.

In one embodiment, determining if said newly scanned image is said base image 604 can comprise comparing said newly scanned image to said base image 604 and analyzing said newly scanned image for distinctions from said base image 604. In one embodiment, if said newly scanned image is substantially similar to said base image 604 said newly scanned image is an embodiment of said base image 604; otherwise, said newly scanned image is an embodiment of said non-base image 605.

FIG. 6D illustrates an embodiment of said image data 514 comprising a target object portion 606a and a base image portion 606b. In one embodiment, where said newly scanned image is an embodiment of said non-base image 605, said image data 514 can be processed to isolate said target object 102 from said base image 604. In one embodiment, said target object portion 606a can comprise a portion of non-base image 605 comprising image data 514 from one or more objects (such as target object 102). In one embodiment, said base image portion 606b can comprise a portion of said non-base image 605 comprising image data 514 substantially similar to said base image 604.

In one embodiment, isolating said target object 102 can comprise: establishing one or more scan zones comprising said target object portion 606a and said base image portion 606b; and cropping said target object portion 606a from said base image portion 606b. Although it would be favorable, not every user of said laptop document scanning system and method will align said target object 102 at right angles with said one or more markers. Accordingly, it would be helpful for said laptop document scanning system and method to isolate, straighten and/or perform an OCR analysis on said image data 514.

In one embodiment, processing said image data 514 can comprise straightening said target object portion 606a of said image data 514. In one embodiment, straightening said target object portion 606a of said image data 514 can comprise: identifying one or more side edges 608 of said target object portion 606a; performing an OCR analysis on said text 122 and said one or more images 120; identifying a likely orientation of said target object portion 606a; rotating said target object portion 606a with said likely orientation; and/or cropping said base image portion 606b. In one embodiment, OCR can comprise “Optical Character Recognition”, as is known in the art. In one embodiment, OCR recognition can comprise algorithmically identifying alpha and numeric characters within said target object portion 606a and reorienting said target object portion 606a with said alpha and numeric characters in a vertical orientation.

In one embodiment, a portion of said target object 102 can be identified with said one or more sensors (such as first sensor 118a and/or second sensor 118b) of said laptop 100. In one embodiment, said one or more sensors of said laptop 100 can determine whether said target object 102 is aligned outside of said edges marker 602 by sensing a portion of said target object 102 between said base portion 104 and a portion of said display portion 106. In one embodiment, said laptop 100 can display a warning that said target object 102 has not been properly aligned.

In one embodiment, scanning a portion of said target object 102 (as discussed supra) can further comprise automatically distributing said image file 516 to one or more designated recipients. In one embodiment, said one or more designated recipients can comprise one or more email accounts. In one embodiment, automatically distributing said image file 516 can comprise attaching said image file 516 to one or more email messages comprising said one or more email accounts of said one or more designated recipients. In another embodiment, automatically distributing said image file 516 can comprise sending said image file 516 by email, server-client protocols, fax, automatic postal systems, or similar. For example, in one embodiment, said image file 516 can be sent wirelessly. In one embodiment, said one or more designated recipients can be selected prior to initiating said scanning a portion of said target object 102. In one embodiment, said distributing and sending of said image file 516 can be accomplished with said communication hardware 510 of said plurality of computer hardware components 502.

In one embodiment, engaging said screen 112 to read a portion of said target object 102 (as discussed supra) can comprise pressing said button 202. In one embodiment, engaging said screen 112 to read a portion of said target object 102 can further comprise placing said laptop 100 into said closed-configuration. In one embodiment, engaging said screen 112 to read a portion of said target object 102 can require that said laptop 100 be in said closed-configuration.

In one embodiment, engaging said screen 112 to read a portion of said target object 102 can comprise: triggering a start command in said software program stored in said memory 506 of said laptop 100. In one embodiment, engaging said screen 112 to read a portion of said target object 102 can comprise: triggering said software program and then closing said laptop 100 into said closed-configuration. In one embodiment, scanning said target object 102 can comprise triggering said software program, placing said target object 102 on said base portion 104, closing said laptop 100 into said closed-configuration, acquiring said image data 514 of said target object 102, processing said image data 514 into said image file 516, and storing said image file 516.

In one embodiment, closing said laptop 100 can comprise engaging a scan every time said laptop 100 is closed; wherein, said scanning hardware 508 can acquire an embodiment of said image data 514 and said processor 504 can process said image data 514 to identify said target object portion 606a and said base image portion 606b every time said laptop 100 is closed.

FIG. 6E illustrates a perspective overview of laptop 100 displaying a scanned image 610 of said target object 102. In one embodiment, said scanned image 610 can comprise said target object portion 606a. In one embodiment, a portion of said image file 516 can be processed and displayed on said laptop 100 as said scanned image 610.

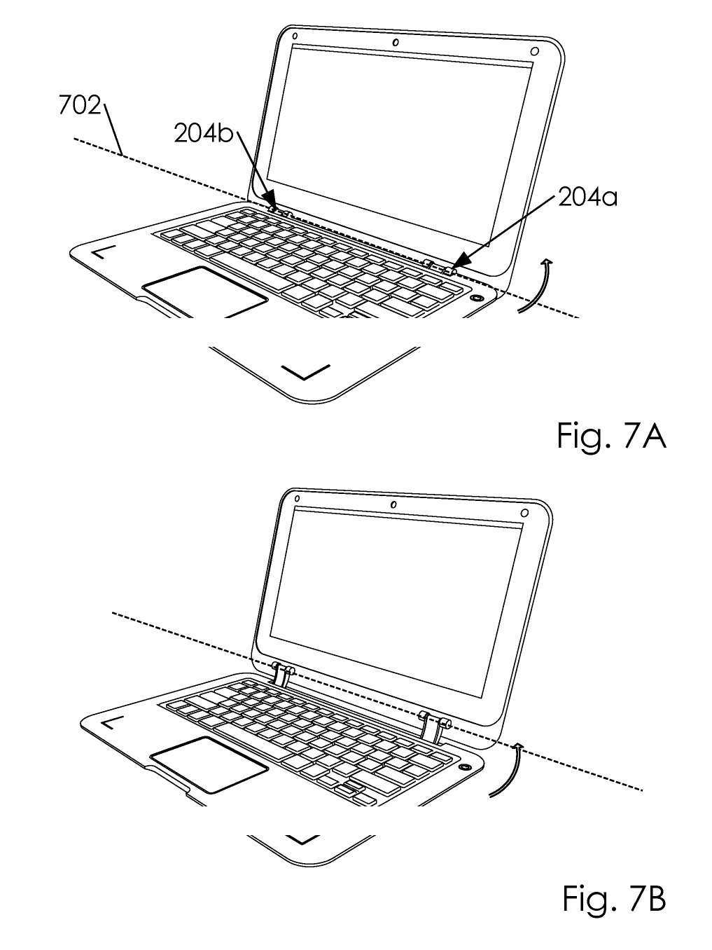

FIGS. 7A and 7B illustrate a perspective overview of laptop 100 in a collapsed-configuration and an expanded-configuration, respectively. In one embodiment, said hinging assembly of laptop 100 can comprise said collapsed-configuration and said expanded-configuration. In one embodiment, said hinging assembly of laptop 100 can comprise a rotating axis 702; wherein, said display portion 106 can rotate relative to said base portion 104 about said rotating axis 702. In one embodiment, adjusting said hinging assembly of laptop 100 from said collapsed-configuration to said expanded-configuration can comprise expanding said hinging assembly of laptop 100 to move said rotating axis 702 above said base portion 104.

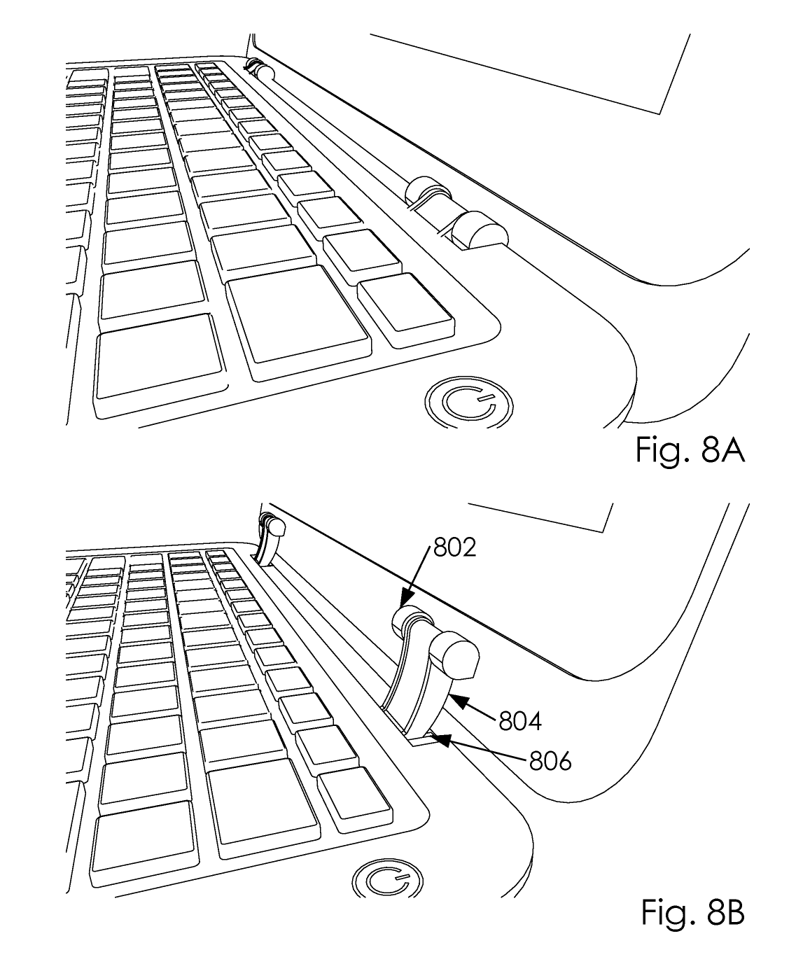

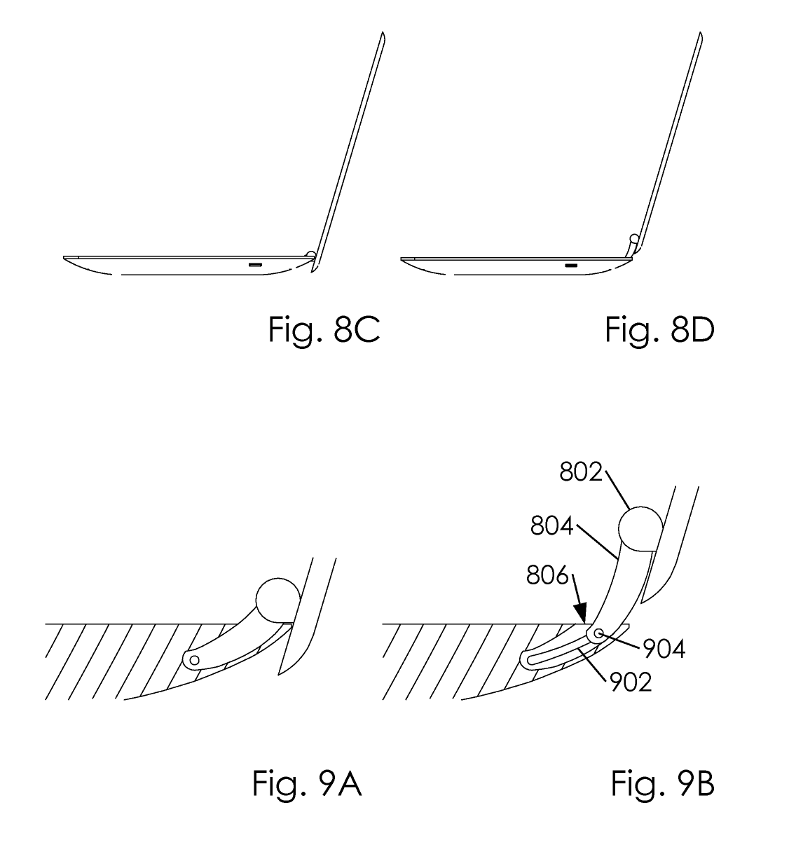

FIGS. 8A and 8B illustrate a perspective detailed overview of said hinging assembly of laptop 100, in said collapsed-configuration and said expanded-configuration. In one embodiment, said first hinge 204a and said second hinge 204b can each comprise a socket assembly 802 and an extendable hinge assembly 804. In one embodiment, said extendable hinge assembly 804 can adjustably slide into a slot 806 in said base portion 104. In one embodiment, said extendable hinge assembly 804 rotatably attach to said socket assembly 802. In one embodiment, said socket assembly 802 can comprise two sockets arranged along two sides of said extendable hinge assembly 804 and capable of rotatably holding a portion of said extendable hinge assembly 804 between said two sockets. In one embodiment, one or more of said socket assembly 802 can attach to said display portion 106 and can receive a corresponding one or more of said extendable hinge assembly 804. For example, in one embodiment, two sets of said socket assembly 802 receive two of said extendable hinge assembly 804, as illustrated in FIGS. 8A-8B.

In one embodiment, one or more power and/or signal cables for said screen 112 can run through one or more of said hinges in said hinging assembly.

In one embodiment, extendable hinge assembly 804 can slide into said slot 806 in order to adjust said laptop 100 into said collapsed-configuration. Likewise, in one embodiment, said extendable hinge assembly 804 can slide out of said slot 806 in order to adjust said laptop 100 into said expanded-configuration.

FIGS. 8C and 8D illustrate an elevated side view of laptop 100 in said collapsed-configuration and an elevated side view of laptop 100 in said expanded-configuration.

FIGS. 9A and 9B illustrate an elevated cross-section side view of said hinging assembly of laptop 100 in said collapsed-configuration and said expanded-configuration. In one embodiment, said slot 806 can receive a portion of extendable hinge assembly 804. In one embodiment, said slot 806 can comprise one or more tracks 902. In one embodiment, extendable hinge assembly 804 can comprise a peg 904. In one embodiment, said peg 904 can slide within said one or more tracks 902. In one embodiment, one or more tracks 902 can define a range of motion for said extendable hinge assembly 804 relative to said base portion 104. In one embodiment, said one or more tracks 902 can restrict said extendable hinge assembly 804 from detaching from said base portion 104.

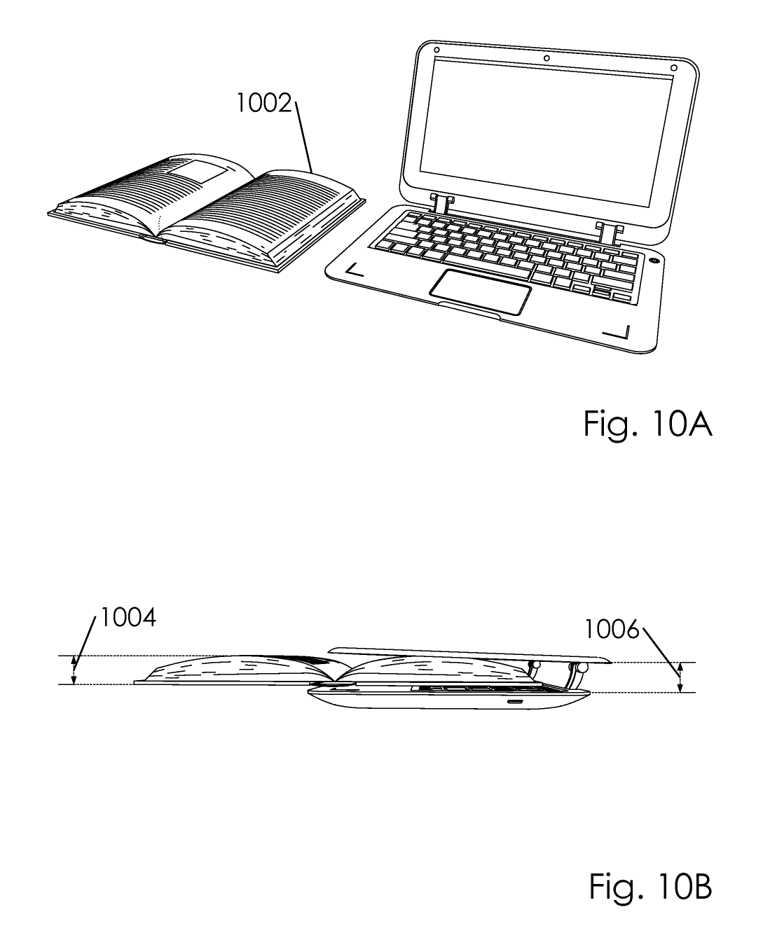

FIGS. 10A and 10B illustrate a perspective overview and side view of said laptop 100 with a book 1002. In one embodiment, said target object 102 can comprise said book 1002. In one embodiment, said target object 102 (such as said book 1002) can comprise a thickness 1004. In one embodiment, said laptop 100 can transition from said collapsed-configuration to said expanded-configuration to accommodate said book 1002 with said thickness 1004. In one embodiment, said hinging assembly of laptop 100 can extend to a height 1006 when in said expanded-configuration. In one embodiment, height 1006 can be equal to or greater than said thickness 1004.

In one embodiment, said laptop 100 can scan book 1002 by: increasing said height 1006 by placing said laptop 100 into said expanded-configuration; placing said book 1002 onto said base portion 104; closing said laptop 100 into said closed-configuration; and engaging said scanning process.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A laptop document scanner comprising a laptop comprising a base portion, a display portion having a screen, and a hinging assembly; wherein,
said screen is capable of emitting light and sensing light;
said hinging assembly is capable of rotatably connecting said base portion to said display portion;
said base portion and said display portion are capable of rotatably transitioning between a closed-configuration and an open-configuration;
said screen is capable of displaying one or more images on said screen;
said screen is capable of scanning one or more images of one or more target objects; and
said base portion and said display portion are capable of holding said one or more target objects while said screen is scanning said one or more images of said one or more target objects.

2. The laptop document scanner of claim 1 wherein said screen comprises an organic light emitting display.

3. The laptop document scanner of claim 1 wherein said screen of said laptop is capable of scanning said one or more target objects by:
placing said screen near said one or more target objects;
engaging said screen to read a portion of said one or more target objects;
acquiring an image data from said screen;
processing said image data into an image file; and
storing said image file with said laptop.

4. The laptop document scanner of claim 3 wherein engaging said screen to read said portion of said one or more target objects comprises:
pressing a button to initiate scanning said one or more target objects.

5. The laptop document scanner of claim 3 wherein engaging said screen to read said portion of said one or more target objects comprises closing said laptop into said closed-configuration.

6. The laptop document scanner of claim 1 wherein said holding said one or more target objects between said base portion and said display portion comprises:
opening said laptop to said open-configuration,
placing said one or more target objects on said base portion, and
closing said display portion over said one or more target objects.

7. The laptop document scanner of claim 1 further comprising one or more markers on said base portion; wherein,
said screen comprises and a circumference;
said one or more markers correspond to a location of a portion of said circumference of said screen on said base portion when said laptop is in said closed-configuration; and
said one or more markers are capable of indicating a portion of said base portion which said screen is capable of scanning.

8. The laptop document scanner of claim 1 wherein,
said laptop comprises a collapsed-configuration and an expanded-configuration;
said hinging assembly of said laptop comprises a rotating axis; and
said hinging assembly of said laptop is capable of expanding to move said rotating axis above said base portion; wherein,
adjusting said hinging assembly of said laptop adjusts said laptop between said collapsed-configuration and said expanded-configuration; and
increasing a height between said base portion and said display portion comprises placing said laptop into said expanded-configuration.

9. The laptop document scanner of claim 8 wherein,
said hinging assembly of said laptop comprises one or more hinges;
said one or more hinges comprise a socket assembly and an extendable hinge assembly;
said socket assembly attaches to said display portion;
said extendable hinge assembly rotatably attaches to said extendable hinge assembly; and
said extendable hinge assembly adjustably slides into a slot in said base portion.

10. A laptop document scanning method comprising scanning one or more target objects with a laptop by:
placing a screen of said laptop near said one or more target objects,
holding said one or more target objects between a base portion and a display portion of said laptop,
engaging said screen to read a portion of said one or more target objects,
acquiring an image data from said screen,
processing said image data into an image file, and
storing said image file with said laptop; wherein,
said laptop comprises said base portion, said display portion having said screen, and a hinging assembly;
said screen is capable of emitting light and sensing light;
said screen is capable of displaying one or more images on said screen;
said screen is capable of scanning one or more images of one or more target objects;
said hinging assembly is capable of rotatably connecting said base portion to said display portion; and
said base portion and said display portion is capable of rotatably transitioning between a closed-configuration and an open-configuration.

11. The laptop document scanning method of claim 10 wherein engaging said screen to read said portion of said one or more target objects comprises:
triggering a start command in a software program to initiate scanning said one or more target objects when said laptop is closed into said closed-configuration,
placing said one or more target objects between said base portion and said display portion, and
closing said laptop into said closed-configuration.

12. The laptop document scanning method of claim 10 wherein engaging said screen to read said portion of said one or more target objects comprises closing said laptop into said closed-configuration.

13. The laptop document scanning method of claim 10 wherein processing said image data comprises
detecting said portion of said one or more target objects in said image data and
isolating said one or more target objects in said image data.

14. The laptop document scanning method of claim 13 wherein detecting said portion of said one or more target objects in said image data comprises:
establishing a base image of said base portion without said one or more target objects between said base portion and said display portion, and
comparing a newly scanned image to said base image; and wherein,
said portion of said one or more target objects are in said image data if said newly scanned image is substantially dissimilar to said base image.

15. The laptop document scanning method of claim 13 wherein isolating said one or more target objects in said image data comprises:
establishing one or more scan zones comprising a target object portion and a base image portion; and
cropping said target object portion from said base image portion; and wherein,
said base image portion comprises a portion of said image data comprising said base image, and
said target object portion comprises a portion of said image data comprising said one or more target objects.

16. The laptop document scanning method of claim 15 further comprising straightening said target object portion by:
identifying one or more side edges of said target object portion;
performing an OCR analysis on said target object portion;
identifying a likely orientation of said target object portion; and
rotating said target object portion with said likely orientation.

17. The laptop document scanning method of claim 10 further comprising
automatically distributing said image file to one or more designated recipients.

18. The laptop document scanning method of claim 17 wherein automatically distributing said image file to one or more designated recipients comprises:
attaching said image file to one or more email messages comprising one or more email accounts of said one or more designated recipients.

19. The laptop document scanning method of claim 10 wherein
acquiring said image data from said screen comprises
collecting said image data from said screen, and
delivering said image data to a memory of said laptop; and,
processing said image data into said image file comprises
delivering said image file to a processor in said laptop, and
converting said image data into said image file.

20. A laptop document scanner comprising:
a laptop comprising a base portion, a display portion having a screen, and a hinging assembly;
said screen is capable of emitting light and sensing light;
said hinging assembly is capable of rotatably connecting said base portion to said display portion;
said base portion and said display portion are capable of rotatably transitioning between a closed-configuration and an open-configuration;
said screen is capable of displaying one or more images on said screen;
said screen is capable of scanning one or more images of one or more target objects; and
said base portion and said display portion are capable of holding said one or more target objects while said screen is scanning said one or more images of said one or more target objects; and wherein,
scanning said one or more target objects comprises
placing said screen near said one or more target objects,
engaging said screen to read a portion of said one or more target objects,
acquiring an image data from said screen,
processing said image data into an image file, and
storing said image file with said laptop.
